(19) United States
(12) Patent Application Publication
(10) Pub. No.: US 2002/0050473 A1
(43) Pub. Date: May 2, 2002

(54) Strainer for collecting debris from a drain

(76) Inventor: Robert N. Davenport, Struthers, OH (US)

Correspondence Address: CLIFFORD A. POFF, 436 SEVENTH AVENUE, KOPPERS BUILDING, SUITE 2230, PITTSBURGH, PA, 152191818

(21) Appl. No.: 10/016,588

(22) Filed: Oct. 22, 2001

Related U.S. Application Data
(60) Provisional application No. 60/241,605, filed on Oct. 20, 2000.

(51) Int. Cl. B01D 35/02

(52) U.S. Cl. 210/447; 210/498

(57) ABSTRACT

A drain strainer for debris is located in drain line segment having a side outlet extending to a drain line flow space. The strainer has a body bounded by side walls contiguous with an annular forward end wall for abutting with the drain flow space to prevent the passage of debris. An array of apertures in the strainer body, which is hemispherical or planner with upstanding sidewalls, is sufficient in number and size to maintain water flow while extracting and retaining debris occurring in the drain line flow space. A closure assembly is formed by a closure plate that supports a seal acted on by a retainer for forming a fluid tight seal with the side outlet opening of the drain line segment.

### CROSS-REFERENCE TO RELATED APPLICATIONS

This application claims the benefit of United States provisional patent application Ser. No. 60/241605 Filed: Oct. 20, 2000, Entitled: Add-a-trap

### BACKGROUND OF THE INVENTION

1. Field of the Invention

The present invention relates to a strainer for extracting debris from waste water discharged from a sink or the like, and, more particularly, to a drain strainer embody in construction in relation of parts to enable cleaning of debris between periods of prolong use of a strainer without undue restriction to the flow of water.

Description of the prior art: U.S. Pat. No. 6,153,095 discloses a filter canister added to a sink drain and includes a dissolvable sanitation table that can be removed for replacement the filter element in the canister. The supported structure for the filter element and the relative size of the element limits the drain area for waste water. As the filter element, formed of mesh material such a fibre plastic, becomes progressively restricted by the entrapment of the debris there is likely to be a restraint to the flow space for the waste water and may actual promote plugging causing water flow stoppage.

It is well known in the art to provide a p-trap or other plumbing facility as a site for debris removal to avoid clogging of the drain line for waste water particularly at inaccessible sites along the course of the drain line. The p-trap or other facility sometimes fails to prevent clogging of the drain and requires the services of a plumber to mechanically remove the debris or the use of chemicals to fragment the clogging matter sufficiently to restore normal flow of the waste water. The use of chemicals introduces a pollutant to the waste water stream and, additionally, introduces a safety hazard to a child's living environment. The operation of a p-trap or other facility to entrap potentially drain clogging substances may be ineffective when small articles e.g. toothpaste caps, are not retained and fail to pass an already existing restriction in a drain line. Also, circumstances occur when it is desirable to recover articles such as rings, contact lenses, etc. inadvertently entering the drain but cannot be recovered by a conventional entrapment facilities. Lastly, it is desirable to allow a systematic removal of materials such as hair from the drain water to avoid the periodic clogging of a particular drain line used to carry hair laden waste water.

Accordingly, it is an object of the present invention to provide a strainer with an effective collection and retention cavity for collecting debris from a drain provided with a drain line segment constructed to support the strainer for ease of cleaning by incorporating the strainer at a drain site that is readily accessible and readily serviceable.

It is another object of the present invention to provide an improved construction for a drain strainer having a debris collection sight sufficiently large and with apertures for waste water to ensure periods of long use without the need to remove debris.

It is a further object of the present invention to provide a drain strainer which can be removed and readily replaced in a drain line without the need of tools and constructed to preclude incorrect assembly to form a water tight structure.

### SUMMARY OF THE INVENTION

According to the present invention there is provided a drain strainer for debris including the combination of a drain line segment having a side outlet extending to a drain line flow space, a strainer including a strainer body bounded by laterally spaced side walls contiguous with an annular forward end wall, the side walls and end wall abutting with the drain flow space for preventing passage of debris there between, the strainer body having an array of apertures for extracting and retaining debris occurring in the drain line flow space and a closure assembly including a closure plate supporting a seal acted on by a retainer for forming a fluid tight seal with the side outlet opening.

Preferably the strainer body is hemispherical forming a concave debris retention area containing the array of apertures sufficient in number and diameter to form strainer flow spaces approximating the drain line flow space. The drain line segment includes spaced apart guides forming strainer support grooves there between for slidably engaging the side walls and annular forward end wall of the strainer at a position to space the hemispherical strainer body from a floor of the side outlet for forming a flow space there between.

### BRIEF DESCRIPTION OF THE SEVERAL VIEWS OF THE DRAWINGS

The present invention will be more fully understood when the following description is read in light of the accompanying drawings in which:

FIG. 1 is an illustration of a typical sink having a drain line suitable for incorporating a strainer of the present invention;

FIG. 2 is a front elevation view of a drain line segment incorporating a first embodiment of the present invention;

FIG. 3 is a section view taken along lines III-III of FIG. 2;

FIG. 4 is a plan view of the strainer basket assembly forming part of the present invention;

FIG. 5 is a view similar to the illustration of FIG. 2 illustrating the second embodiment of the present invention;

FIG. 6 is a section view taken along lines VI-VI of FIG. 5;

FIG. 7 is a plan view of a strainer basket assembly forming part of the second embodiment of the present invention;

FIG. 8 is a side elevation view of the strainer basket assembly shown in FIG. 7; and

FIG. 9 is an end view of the strainer basket assembly shown in FIG. 7.

### DETAILED DESCRIPTION OF THE INVENTION

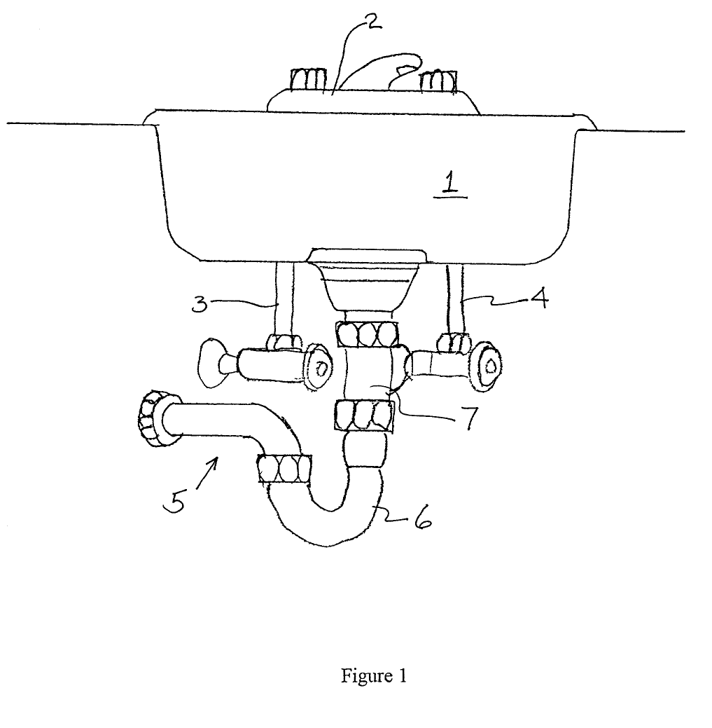

FIG. 1 illustrates a typical sink 1 provided with a faucet assembly 2 supply with water from conduit lines 3 and 4. Water received in the sink is put to waste by a drain line assembly 5 that includes the usual J pipe section 6 joined to an upstream drain line 7 extending to the sink 1.

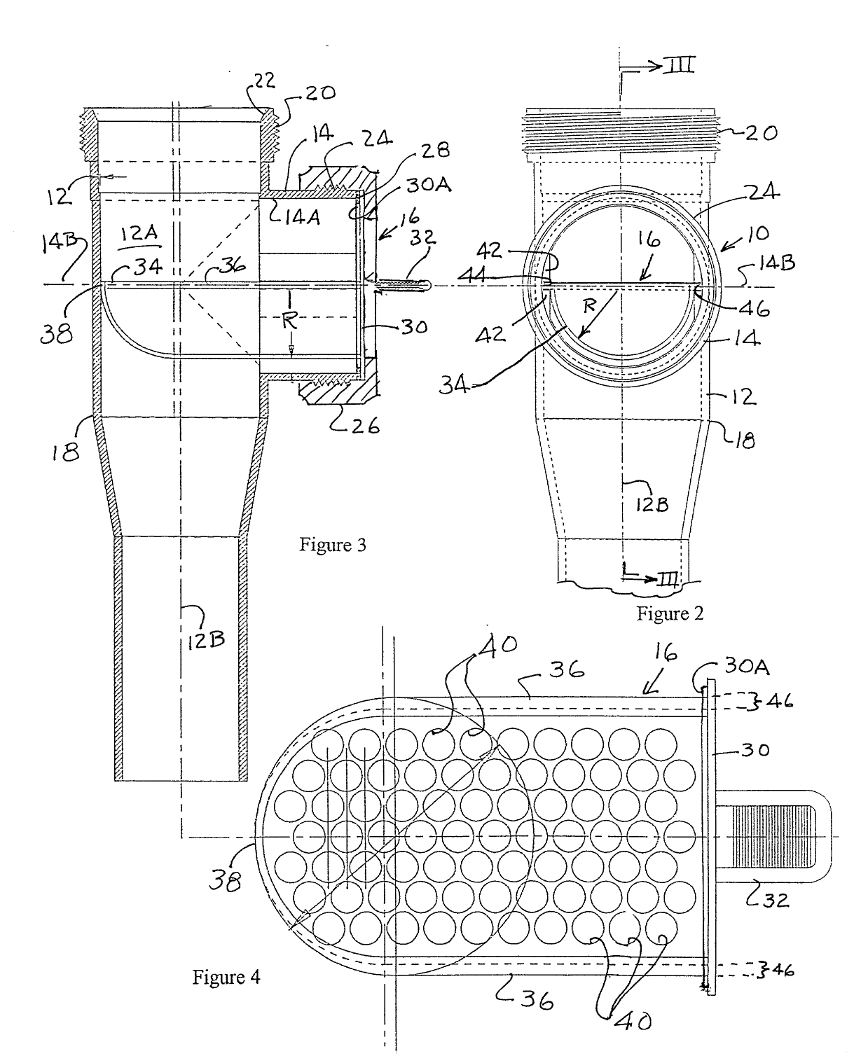

FIGS. 2-4 illustrate a first embodiment of a drain strainer 10 according to the present invention. The drain strainer uses a drain line segment 12 forming part of drain line 7 and having a tubular side outlet 14 with an inside diameter 14A preferably slightly larger than the inside diameter of the drain line flow space 12A in the drain line segment 12 to maximize the size of a strainer assembly 16. The side outlet 14 is defined with an outlet central axis 14B perpendicular to and intersecting a central axis 12B of the drain line flow space 12A. It is within the scope of the present invention to use a Tee provided with compression fittings to form the required drain line segment and tubular side outlet. The piping and strainer forming the present invention can embody materials of construction belonging to the group consisting of plastic (e.g., PVC and polypropylene), copper, brass and ferrous metals. The diameter of the drain line flow space 12A may, if desired, be reduced at a site 18 down stream of the tubular side outlet 14 to accommodate preexisting pluming conditions. External threads 20 encircle the upstream end of the drain line segment 12 where there is also located a beveled edge 22 forming a compression site for an annular seal as, per se well known in the art, for forming a compression seal with the use of a threaded nut member, not shown. External threads 24 are formed on the protruding end portion of the tubular side outlet 14 for receiving a nut member 26 to compress a flat rubber washer 28 supported by an annular recess 30A between a face plate 30 and the end face of the tubular side outlet 14 for forming a fluid tight closure for the tubular side outlet 14.

The face plate 30 is part of the strainer assembly 16 which also includes a handle 32 extending from the face plate 30 at a side thereof opposite the location of a strainer body 34 and secured to and extends from the planer surface of the face plate. The handle 32 plate dimensioned to enable a user to support and manipulate the strainer body for removal, cleaning and replacement in the tubular side outlet 14. The strainer body 34 is bounded by laterally spaced side walls 36 contiguous with an annular forward end wall 38 to define a configuration for abutting with the internal wall surfaces at the junction of the internal flow space 12A and the internal wall of the tubular side outlet 14 for preventing passage of debris between the strainer body and the internal wall surfaces.

The strainer body in the embodiment of FIGS. 2-4 takes the form of a generally 20 hemispherical shape struck about a radius R transverse to the extended length thereof forming a concave debris retention area containing the array of apertures 40 for extracting and retaining debris occurring in the drain line flow space on the floor wall between the apertures. The apertures 40 are sufficient in number and diameter to form strainer flow spaces approximating the drain line flow space, although distributed throughout an area comprising the flow space 12 A and the extended length of the side outlet 14. The side walls 36 and the end wall 38 engage the side outlet within a plane of support for the strainer remote to the outlet central axis 14B sufficiently upstream along the central axis 12B of the drain line flow space to prevent inverted support of the strainer body 34 in the side outlet. The internal wall of the tubular side 14 includes spaced apart guides 42 forming strainer support grooves 44 there between for slidably engaging the side walls, which are generally parallel and an annular forward end wall of the strainer. The side walls 36 and the end wall 38 are formed with support rails 46 protruding from the side walls and the end wall to engage between the guides 42 for resisting torque acting on the strainer during placement of the nut member 26. The support rails 46 are positioned to extend from the walls of the drain line segment to space the hemispherical strainer body from a floor of the side outlet for forming a flow space there between.

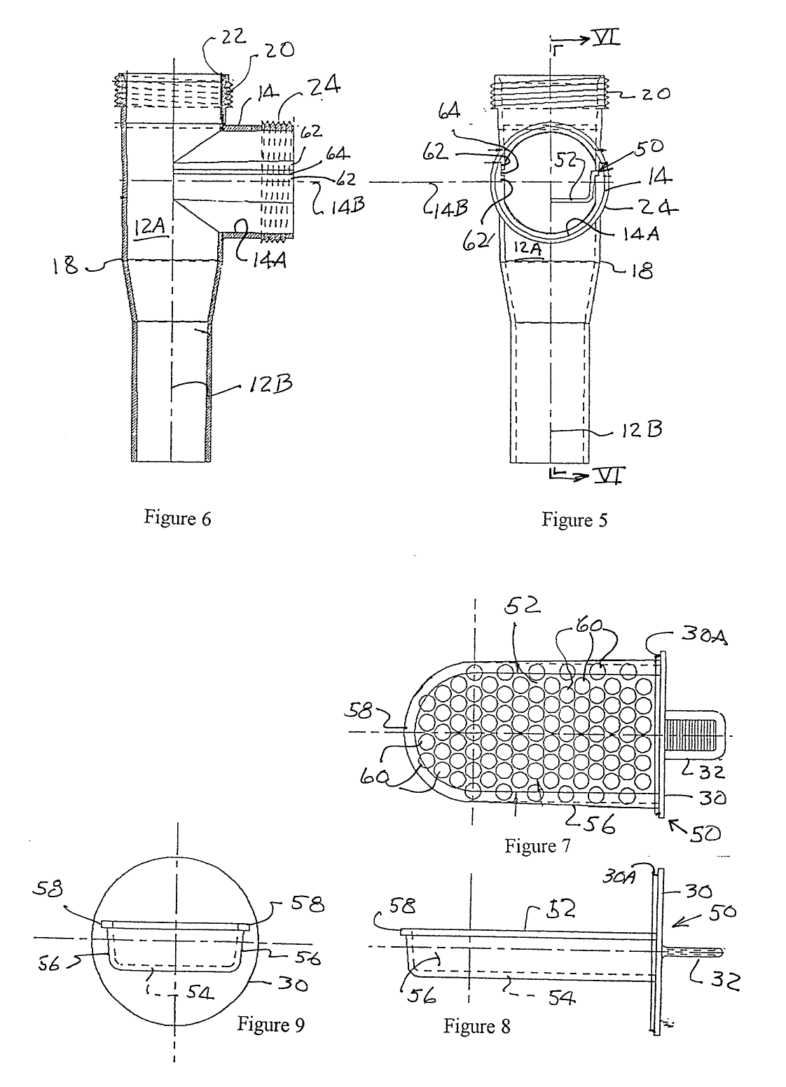

FIGS. 5-9 illustrate the second embodiment of the present invention which differs from the first embodiment essential by the construction of the strainer body and the location of the support rails in the side outlet for supporting the strainer body. Like reference numerals in the FIGS. 5-9 denote the same structure described hereinbefore and illustrated in FIGS. 2-4. The strainer assembly 50 is provided with a strainer body 52 having a concave shape transverse to the extended length form by a generally plainer floor wall 54 surrounded by an upstanding sidewall 56 terminating with a latterly outward support rail 58. The floor wall 54 is formed with array of apertures 60 for extracting and retaining debris occurring in the drain line flow space on the floor wall between the apertures. The strainer body 52 is integrally formed as part of the face plate 30. The internal wall of the tubular side outlet 14 is formed with spaced apart guides 62 forming strainer support grooves 64 there between for slidably engaging the support rail 58 and retaining the strainer body at a displaced position such that the floor wall 54 is sufficiently remote to the underline surface of the tubular side outlet 14 to form a flow space there between.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

1. A drain strainer for debris, said drain strainer including the combination of:
a drain line segment having a side outlet extending to a drain line flow space;
a strainer including a strainer body bounded by laterally spaced side walls contiguous with an annular forward end wall, said side walls and end wall abutting with said drain flow space for preventing passage of debris there between, said strainer body having an array of apertures for extracting and retaining debris occurring in said drain line flow space; and
a closure assembly including a closure plate supporting a seal acted on by a retainer for forming a fluid tight seal with said side outlet opening.

2. The strainer for debris according to claim 1 wherein said drain line is tubular with opposed sides extending to opposed linear sides forming part of said side outlet.

3. The strainer for debris according to claim 1 wherein said side outlet is tubular having an outlet central axis perpendicular to and intersecting a central axis of said drain line flow space.

4. The strainer for debris according to claim 1 wherein said strainer body is hemispherical forming a concave debris retention area containing said array of apertures and wherein said side walls and said end wall engage said side outlet within a plane of support for said strainer remote to said outlet central axis sufficiently upstream along said central axis of said drain line flow space to prevent inverted support of said strainer in said side outlet.

5. The strainer for debris according to claim 1 further including a strainer support traversing said drain line flow space.

6. The strainer for debris according to claim 1 wherein said drain line segment includes spaced apart guides forming strainer support grooves there between for slidably engaging the side walls and annular forward end wall of said strainer.

7. The strainer for debris according to claim 6 wherein said strainer includes support rails protruding from said side walls and said end wall to engage between said guides for resisting torque acting on said strainer during placement of said retainer.

8. The strainer for debris according to claim 1 wherein said strainer body is hemispherical forming a concave debris retention area containing said array of apertures.

9. The strainer for debris according to claim 1 wherein said strainer further includes parallel side walls residing along parallel sides of said side outlet.

10. The strainer for debris according to claim 9 wherein said strainer body is a hemispherical between laterally spaced support rails retained by walls of said drain line segment at a position to space the hemispherical strainer body from a floor of said side outlet for forming a flow space there between.

11. The strainer for debris according to claim 1 further including a handle extending from said plate at a side thereof opposite said strainer, said strainer being secured to said plate.

12. The strainer for debris according to claim 11 wherein said plate includes a retainer for said seal.

13. The strainer for debris according to claim 1 wherein said apertures are sufficient in number and diameter to form strainer flow spaces approximating said drain line flow space.

14. The strainer for debris according to claim 1 wherein said drain line flow space downstream of said strainer has a reduced diameter.

15. The strainer for debris according to claim 1 wherein said retainer comprises a nut member having threads for engaging threads encircling said side outlet.

16. The strainer for debris according to claim 1 wherein said strainer body includes a plainer floor between upstanding side walls having laterally extending support rails retained by walls of said drain line segment at a position to space the strainer body from a floor of said side outlet for forming a flow space there between.
